(19) United States
(12) Patent Application Publication
(10) Pub. No.: US 2005/0137942 A1
(43) Pub. Date: Jun. 23, 2005

(54) Rapid depolyment portable interactive kiosk

(76) Inventor: Bernard B. LaFleur, Polaski, VA (US)

Correspondence Address: Richard C. Litman;Litman Law Offices, Ltd., Crystal City Station, P.O. Box 15035, Arlington, VA, 22215-0035, US

(21) Appl. No.: 10/943,212

(22) Filed: Sep. 17, 2004

Related U.S. Application Data
(60) Provisional application No. 60/503,483, filed on Sep. 17, 2003.

(51) Int. Cl. G06F 17/60

(52) U.S. Cl. 705/27

(57) ABSTRACT

A portable information kiosk. The kiosk has a self contained power supply for a computer, a display, a digital camera, a cellular, satellite capable telephone, an antenna, a printer and a flat bed scanner, all electrically connected to each other and capable of being stored in a small carrying case. A method of deploying the kiosk does not require any attaching of parts together and can be done quickly. The kiosk is ideal for in the field communications and data acquisition, such as in disasters, emergencies, or any in the field environmental monitoring.

### CROSS-REFERENCE TO RELATED APPLICATION

This application claims the benefit of U.S. Provisional Patent Application Ser. No. 60/503,483, filed Sep. 17, 2003.

### BACKGROUND OF THE INVENTION

1. Field of the Invention

This invention relates to a portable kiosk having a computer and telecommunications capabilities, and that can be used in the field in an emergency or other remote activity.

2. Background of the Invention

Various components and systems currently exist in the marketplace attempting to address the requirements of “Interoperable Communications.” The systems that have the largest range of functional technology are housed within large wheeled or track vehicles. Others are housed within mobile trailer configurations that must be towed to the site. Some of these types of mobile solutions incorporate a vast array of technology enabling “Interoperable Communications” from the physical location of the unit once it is deployed and operational.

The problem with these solutions is multifaceted, beginning with the technology being housed in a wheeled or track vehicle. Past events such as 9/11 and its aftermath, hurricane Andrew, San Francisco earthquake (1989 Loma Prieta) and the 2003 New York City power grid failure have clearly illustrated the difficulty or impossibility of bringing the capabilities contained in these mobile vehicles to bear on site. Debris, infrastructure failure (bridges), inaccessible roadways, and evacuation routes used by pedestrians make access to the emergency site difficult if not impossible.

An additional concern with these types of mobile units is the need for electrical power. Some use the vehicle's engine to provide sufficient electrical power. Others use generators or an array of battery systems, while others still require an external power supply and are dependant on them exclusively.

Another major issue is the manpower required to deliver, setup and operate these types of mobile response units. Many of the subsystems are not intuitive in use or setup, and must be operated by highly trained and skilled individuals. Deploying these types of mobile response units takes a lot of time, manpower, energy and resources.

Access to these mobile response units is often reserved for only the highest level of authority. Usage of the mobile response units by front line first responders or on-scene incident commanders are rarely if ever available. Mobile response units are also highly vulnerable to drive train failure. This failure could manifest itself in the form of a flat tire, engine failure, overheating, broken or damaged axles and a host of other mechanical problems or failures.

The cost of mobile response units is very expensive running as high as several hundred thousands of dollars for a single unit. The high cost of these units is a barrier to the mission goal for acquisition and usage of interoperable communications for national, state, local, and commercial organizations to strengthen homeland security. Other solutions with limited functional technology include the usage of portable computers, cell phones, satellite phones, personal digital assistants and similar devices.

Some of these solutions combine a number of components packaged into weather resistant transportable cases. These types of devices may include very rugged and powerful laptop computers with ancillary components such as printers and scanners either partially connected or contained within the weather resistant transportable cases to be connected upon need or during setup. Some transportable units require multiple cases to provide the level of interoperable communications required.

These types of transportable systems are a kludged response of mostly commercial-off-the-shelf (COTS) products not specifically designed for the task. However the inherent ability to bring technology to bear directly at the response site is very desirable and is a distinct advantage over mobile response units.

Current transportable systems have many shortcomings and fail to adequately provide a comprehensive solution to the problem. Some of the problems include the inability to operate in varied environmental conditions ranging from daylight readability through extreme climate conditions.

Many of the accouchements, subsystems (telephone, printer, scanner) can be cumbersome to connect and can easily be separated from the unit (i.e.: A user walks away with the cell phone). On site, many cables, connectors and subsystems must be connected or deployed for the transportable system to operate successfully. Many of the subsystems are not intuitive to use or setup and must be operated by highly trained and skilled individuals. These various subsystems also require a variety of separate battery supplies and charging systems for

These types of transportable systems also require the user to locate a table or platform to place the unit upon or otherwise it must be placed directly on the ground and operated from a kneeling or other difficult position. General public usage is not viable due to the configuration and layout of these current transportable systems. This inherent design limitation fails to address the entire life cycle requirement of an event, which includes usage by the general public for relief aid processing and community restoration. The man-machine interface is not well thought out. Ease of use or access by individuals with a disability or operation while wearing a decontamination suit or winter clothing has not been adequately addressed or access provided. The costs of these types of transportable systems are highly dependent on the peripherals and configuration of the unit, ranging in price from fifteen thousand dollars to over fifty thousand dollars per unit.

The current systems have not yet supplied the emergency response community with the technology that it needs for this mission. For example, the kiosk in U.S. Pat. No. 6,289,326 to the Applicant does not fold away into a small case, and does not have the telecommunications technology needed for on the field monitoring. Therefore, what is needed is a more portable kiosk that also has telecommunications capabilities so that information can be gathered and sent and received from a remote location in the field.

### SUMMARY OF THE INVENTION

It is therefore, an object of the present invention to provide for an improved interoperable communications device that solves the above problems.

It is also an object of the present invention to provide a portable kiosk that has telecommunications functions along with data gathering functions.

It is further an object of the present invention to provide a kiosk that can be folded into a relatively small water and air tight compartment for transport.

It is further an object of the present invention to provide a kiosk with integrated functions of a keyboard, a flat bed scanner, a telephone, a wireless LAN, a GPS receiver, a cellular voice/data communications module, a satellite voice/data communications module, a display, a printer, a computer, a card reader, a bar code reader, a biometric ID fingerprint scanner, a digital camera, speakers, battery power supply, an antenna in a single kiosk that is portable and does not require much skill or time to set up and store away.

It is further an object of the present invention to provide a method for deploying and a method for folding away the above interactive kiosk where no parts need to be assembled and the kiosk can be easily folded away.

These and other objects may be achieved by a kiosk that has telecommunication functions, data input and output functions, and computer functions. In particular, the portable kiosk of the present invention has 1) a battery power supply, 2) electronics for recharging, 3) a computer with hard disk drives, 4) an LCD display that is touch sensitive, 5) a keyboard, 6) a scanner, 7) a GPS, 8) a digital video camera, 9) a printer, 10) cellular and satellite communications, 11) radio communications, 12) internet connections, 13) fingerprint readers and card readers for security and 14) accessibility to disabled persons. All of these features are present in a kiosk that can be easily folded into a water-tight and air-tight compartment that is about 24.5 inches wide, 27.5 inches long and only 18.5 inches high.

This device is known as the “Rapid Deployment Portable Interactive Kiosk” or RDPiK. It is a comprehensive solution answering the need for a unified interoperable communications delivery platform designed to meet the mission critical requirements of homeland security. Further, this device provides incident commanders, first responders, federal, state and local agencies and commercial organizations with an effective communications platform to effectively plan for pre-incident action, respond to actual events and provide general public access for relief aid processing and the restoration of community services. The RDPiK is designed for the entire life cycle of an emergency event. These and other objects can be achieved by the Rapid Deployment Portable Interactive Kiosk (RDPiK) that is at its core a folding, portable interactive kiosk designed for indoor and outdoor use. This device measures (approximately) 24.5″ wide×27.5″ length×18.5″ height in its folded and closed position and weighs under 95 lbs fully configured and easily fits in the trunk of most vehicles and can be shipped by commercial overnight carriers. The RDPiK is man portable with built-in heavy-duty handles and lifting/tie down rings. A telescoping handle extends for ease of handling and leverage to move or steer the RDPiK on the integral oversized wheels or casters. The external structure of this unit is constructed of a rotationally molded polyethylene resins case. The case is securely closed with molded-in stainless steel catches, strikes and hinges. It is an airtight and watertight case complete with an integral pressure relief valve and is designed to survive handling mishaps and to keep the internal electronic components safe and functional meeting military specifications. The case has molded in ribs and channels for self-alignment when stacking multiple units. The case features skid resistant ribs on the base to assure stable operation. Deployment is straightforward and assisted by internal gas pistons and engineered lifting mechanisms. To deploy the RDPiK one simply rolls the unit into position, unlock the catches on the exterior case structure and open the case. One then presses the single button locking mechanism, and the unit will automatically unfold to its first position; pressing the same button again then releases the screen/keyboard/scanner assembly from its stowed positing rotating into its deployed state. No time is wasted waiting for the system to startup, as it is designed for instant on usage and is automatically activated when deployed. All peripherals are pre-connected and configured for immediate usage. This device does not require any special equipment or talent to deliver to the site, setup or deploy. The entire electronics complement of the unit “floats” in three-dimensional sway space within the external case structure suspended on vibration and shock dampening isolators. During the deployment process the electronics complement engages a pair of “stud bolts” firmly locking and restricting the movement of the electronics complement to the case structure itself. The nested structural folding struts are machined from aircraft quality anodized aluminum. In addition to the inherent strength to weight ratio of this material it also possesses highly desirable decontaminable properties consistent with the mission critical design. The RDPiK when deployed is designed as a full function kiosk and stands at 54″ tall overall permitting ease of usage by persons either standing or seated (i.e. wheelchair user) for man machine interface with the technology. The following is a list of the major components and features: Battery Supply: This device features an internal self-contained, Lithium-ion polymer cell battery supply capable of operating in excess of 4 hours under full load usage without any external power source. Hot swappable battery modules are also available. Power Electronics: External power input for operation or recharging is accomplished through the use of a sophisticated power input regulation module that permits AC or DC, Military or Civilian power sources to be used worldwide. Additional sources for recharging options include a folding portable solar panel charging module. Computer System: Ultra-rugged personal computer designed for low weight factor and high-end performance that offers expanded functionality from multiple digital and analog inputs and outputs for usage and connectivity. The hard disk drive is shock mounted and is available as a solid-state drive. LCD Display: Sunlight readable LCD monitor incorporating thermal management and auto-dimming. The touchscreen is designed to work with a gloved hand in the harshest of environments. A video out connector is provided for external connectivity to other display devices. Video: A digital video camera is located on the unit enabling video conferencing from on site. An additional wireless video camera system is optionally available for the transmission and review of remote live video feeds. Keyboard/Scanner: The keyboard is a highly rugged, waterproof design backlit for nighttime operations. The keyboard assembly functions as the lid mechanism for the digital flatbed optical scanner system located directly below. The flatbed scanner is capable of scanning passports, books, and small objects as well as traditional sheet paper items. Global Positioning System: The unit has an integrated GPS capable of providing the precise location of the unit deployment. When the line of site to the sky is obstructed, a remote antenna pod is deployable from the unit. Printer: The integrated printer offers a compact and highly versatile roll fed design that can print complete website pages, text, bar codes, graphics and maps. Access to the printed material is through a sealed access door located at the front of the deployed unit. This access door can be left closed while operating protecting the printed material from the elements until needed. Telecommunications: Secure, reliable and redundant telecommunications are achieved through integrated cellular and satellite communication modules controlled through the computer system.

Encryption technology is optionally available. Radio Communications: Tactical interoperability is achieved by linking up to 3 radio groups (i.e.: 800 Mhz, VHF, UHF) to this unit. As responding agencies arrive on scene, they place their portable radio into the unit and connect a single cable and it instantly links disparate radio systems permitting simultaneous communications. Encryption technology is optionally available. Data Communications: Secure, reliable and redundant data communications are achieved through integrated cellular and satellite data modules controlled through the computer system. Wireless connectivity (802.11) is incorporated in the system together with external hardwire connectivity options. Voice over Internet Protocol (VoIP) is available through these modules. Encryption technology is optionally available. Identification: Validation of user or identification can be achieved through a multitude of formats. Integrated components in this unit include: digital camera, smart card insert reader, magnetic stripe card reader, barcode reader and fingerprint reader. Other traditional forms of access are also available including password keyboard entry. Accessibility: Cross disability access is gained through the use of a combination of tools including: keyboard, touchscreen, pointing device and sound system. Incorporated in this unit is the patented EZ Access system developed by Dr. Gregg Vanderheiden of the University of Wisconsin, Trace R&D Center. The following reference patents by Dr. Vanderheiden:
“Touchscreen for the vision impaired,” U.S. Pat. # 6,384,743, May 7, 2002
“Control Panel for Individual with Disabilities”, U.S. Pat. # D451,482, Dec. 4, 2001
“Flexible access system for touchscreen devices”, U.S. Pat. # 6,049,328, Apr. 11, 2000 The multi-role mission critical requirements for homeland security require a comprehensive solution answering the need for a unified interoperable communications delivery platform. The RDPiK represents the evolution in technology required to fulfill this mission critical objective from pre incident planning and training through event response and finally to community restoration. The current technology cannot compare to the complete embodiment of these features and solutions contained in the RDPiK. This unit is designed to take full advantage of technology upgrades when they become available. The module design of integrated components permits ease of upgrade to the latest technology in computers, processors, power supply and communications. This insures that an investment in the RDPiK will provide a valued system for years beyond the initial state of the deployed technology.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a front-right view of the inventive deployed kiosk according to the principles of the present invention;

FIG. 2 illustrates a front-left view of the deployed kiosk of FIG. 1 with the scanner and not the keyboard in use according to the principles of the present invention;

FIG. 3 illustrates the kiosk in a closed and in a portable case according to the principles of the present invention;

FIG. 4 illustrates a front view of the inventive deployed kiosk according to the principles of the present invention;

FIG. 5 illustrates a back view of the deployed inventive kiosk according to the principles of the present invention;

FIG. 6 illustrates a left side view of the deployed inventive kiosk according to the principles of the present invention;

FIG. 7 illustrates a left back view down onto the deployed inventive kiosk according to the principles of the present invention; and FIG. 7A is a detail view in conjunction with FIG. 7.

FIGS. 8, 9 and 10 illustrate the method for deploying and closing the inventive kiosk according to the principles of the present invention.

### DETAILED DESCRIPTION OF THE INVENTION

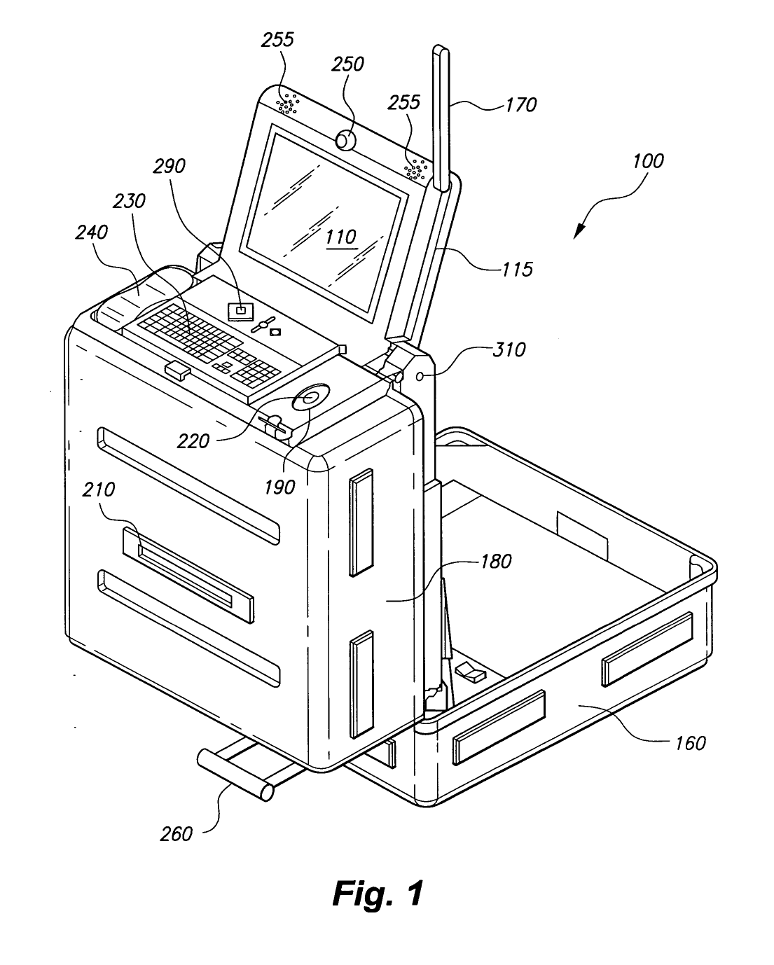

Turning to the figures, FIG. 1 illustrates the Rapid Deployment Portable Interactive Kiosk (RPPiK) 100 according to the principles of the present invention. The kiosk 100 in FIG. 1 is in a fully deployed position. As illustrated in FIG. 1, keyboard 230 is disposed 35 inches off the ground. Keyboard 230 is preferably a spill proof keyboard. Behind keyboard 230 is an EZ Access™ section 508 ADA compliant interface 290 enabling persons with limited hand use and/or limited or no vision to use the kiosk. To the left of keyboard 230 is a telephone handset 240. Telephone handset 240 has a volume control and has a jack for a headset. The telephone handset 240 along with the other features of the kiosk can enable the user to command and control teams of people in an emergency. To the right of keyboard 230 is biometric ID 220. Biometric ID 220 is a fingerprint scanner that is used to either grant or deny access of certain persons to the kiosk. The biometric ID 220 can provide usage authorization, ID comparison and validation and process records. Behind keyboard 230 is LCD panel 110. The LCD panel 110 is preferably a daylight readable touch screen display that can even be activated by a person using gloves. About display 110 is a brushed aluminum housing that is maintenance free for ease of cleansing or decontamination and thermal management. At a top edge of the LCD panel 110 is a digital camera 250. Digital camera can be used for ID comparison, validation, and for video conferencing. On either side of camera 250 are stereo speakers 255. At one end of the top edge of the LCD panel 110 is antenna 170. Antenna 170 is used for GPS (global positioning system) as well as cellular, satellite and wireless communications. On a front side of the kiosk 100 is a sealable opening 210 where paper from the printer can come out. Also illustrated in FIG. 1 is a card reader 190 for smart cards and magnetic stripe cards allowing access to the kiosk to certain persons.

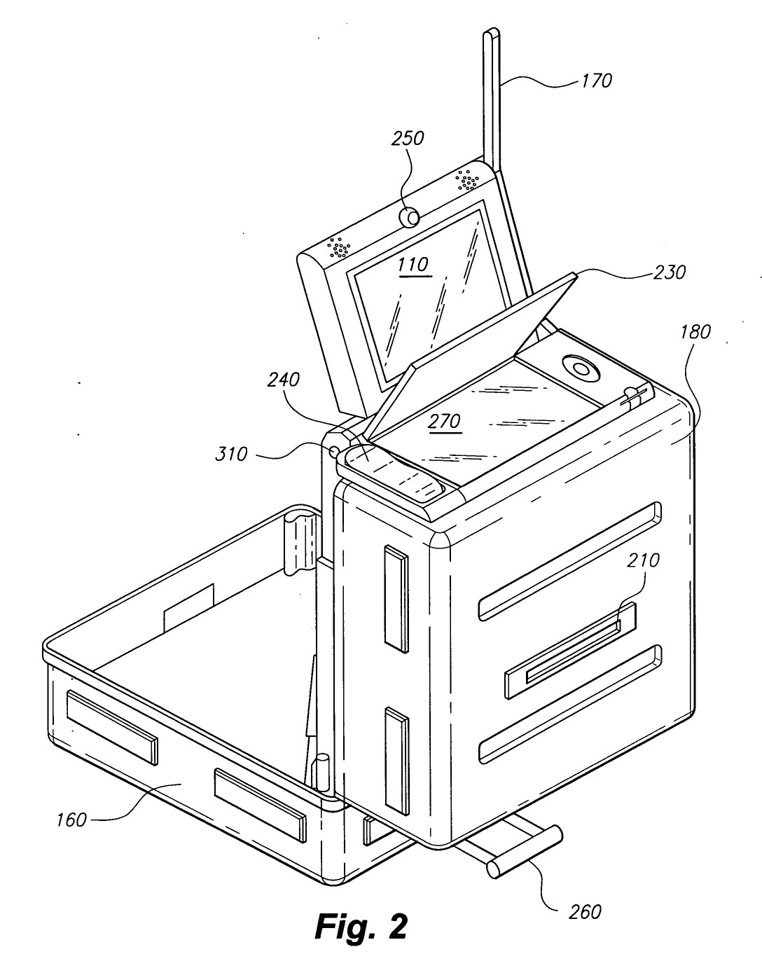

Turning now to FIG. 2, FIG. 2 illustrates the color scanner 270 disposed underneath keyboard 230. In order to access scanner 270, keyboard 230 is rotated about first axis 310 towards LCD panel 110 exposing scanner 270. Scanner 270 is preferably a digital flatbed color scanner with a clutch lid assembly. The scanner can be used to scan insurance records, photographs of missing persons, small objects and for facsimile or photocopying purposes.

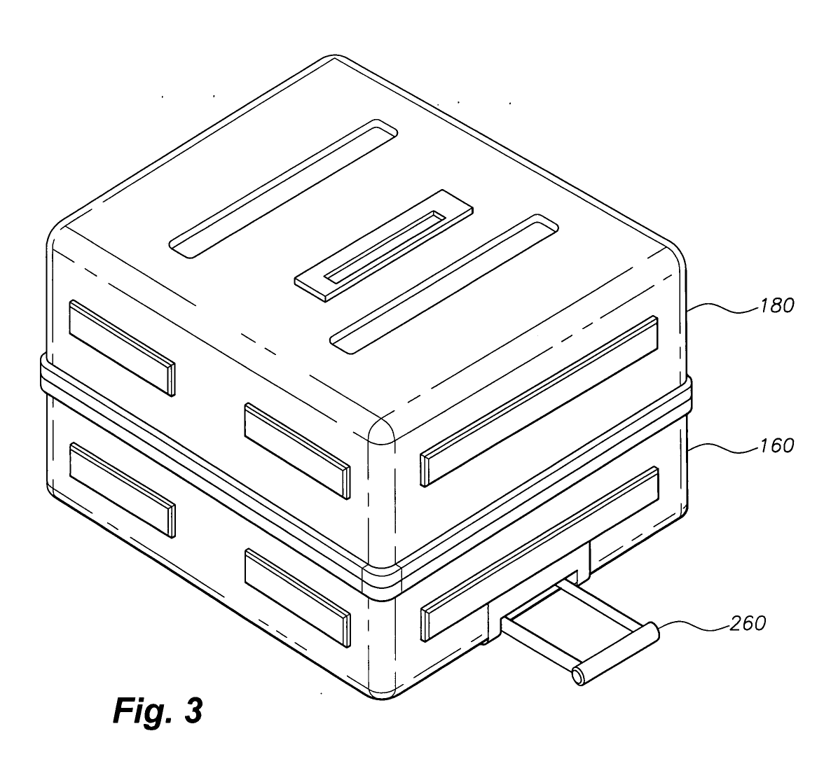

Turning to FIG. 3, FIG. 3 illustrates the kiosk completely folded up and ready for transport. Preferably, the dimensions of the container illustrated in FIG. 3 are 24.5 inches wide, 27.5 inches long and only 18.5 inches high. Preferably, the container is both airtight and water tight, and contains a low altitude pressure relief valve. Also, the case is preferably resistant to physical or mechanical shock and is thus compliant with Mil-Std-810. The weight of the loaded container is 95 lbs. Handle 260 is disposed at one end of the container for transport. At an opposite end are a pair of casters 220 (not illustrated in FIG. 3) for transport.

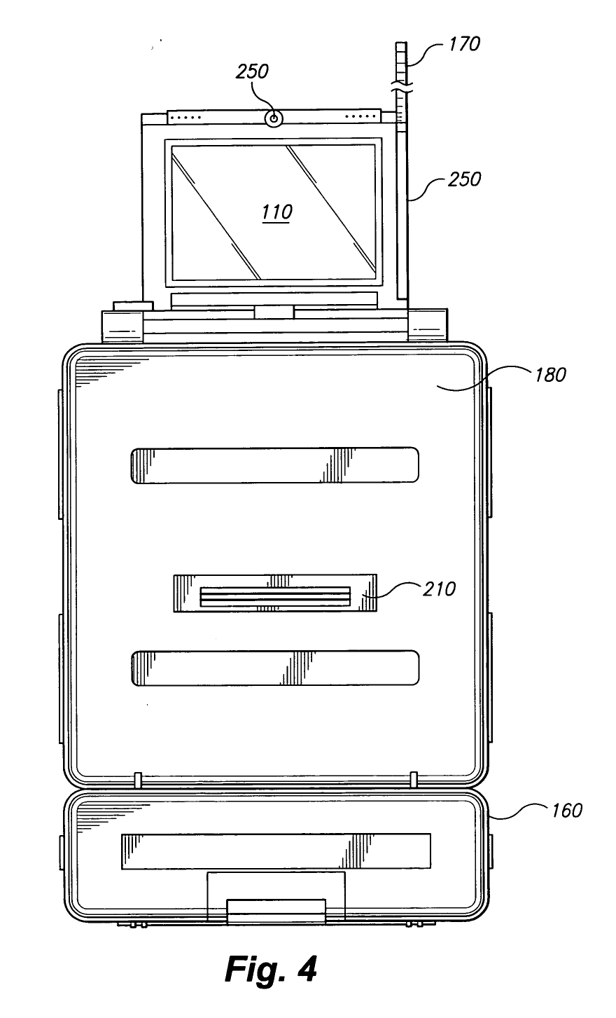

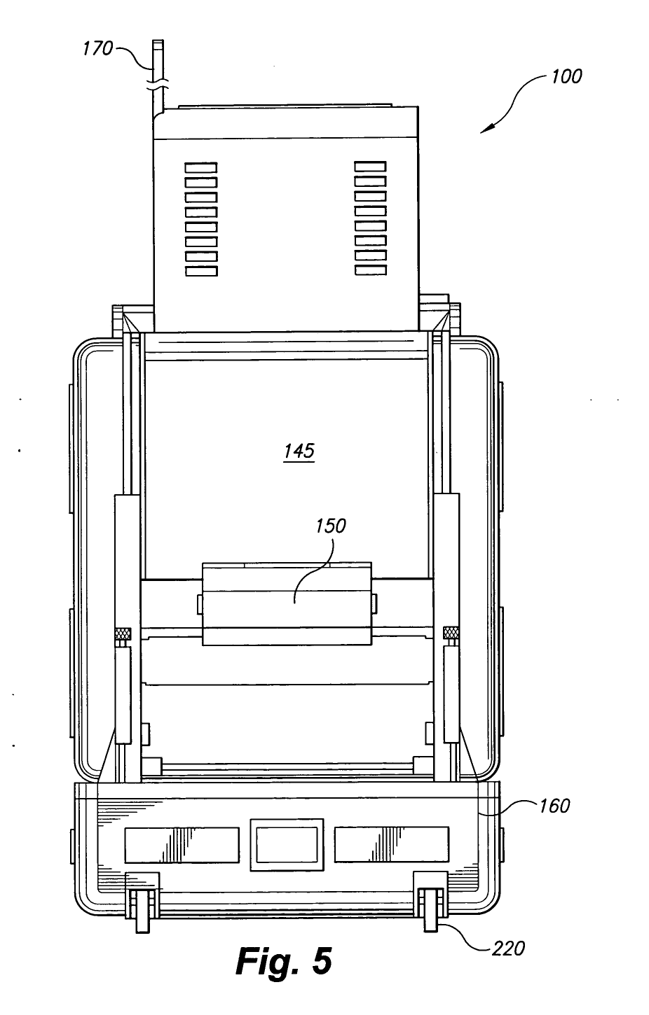

Turning to FIG. 4, FIG. 4 illustrates a front view of the kiosk when fully deployed. LCD panel 110 is open and the top side 180 of the case is upright. Handle 260 is towards the front of case bottom 160. Handle 260 is a retractable handle and is designed to remain partially exposed in the deployed position to assist in stabilizing the device. FIG. 5 illustrates a backside of the kiosk. Paper roll 150 is disposed near opening 210 in the top portion 180 of the case. The paper supply 150 is capable of housing rolls as large as 8½ inches wide and 1200 feet long. The paper 150 is a daylight stable paper. The paper 150 is fed into the printer (not illustrated) that is a high-peed printer with high-resolution graphics capability. The printer can be used to print forms and applications, directions and maps as well as instructions. The printed image is fed through slot 210 on the front side of the kiosk. Also on the backside is a rugged designed computer 145. The computer 145 can connect to the Internet via the antenna 170, or the external communications pod 330. The computer 145 is capable of running many software applications and also allows access to material safety data sheets and preplanned response information. This computer 145 is electrically connected to display 110, the printer, the keyboard 230, and all of the other electronic components in the kiosk. Computer 145 is a highly rugged design and contains a minimum of moving parts. Also visible in the rear view of FIG. 5 are casters 220 also face a backside of bottom case 160.

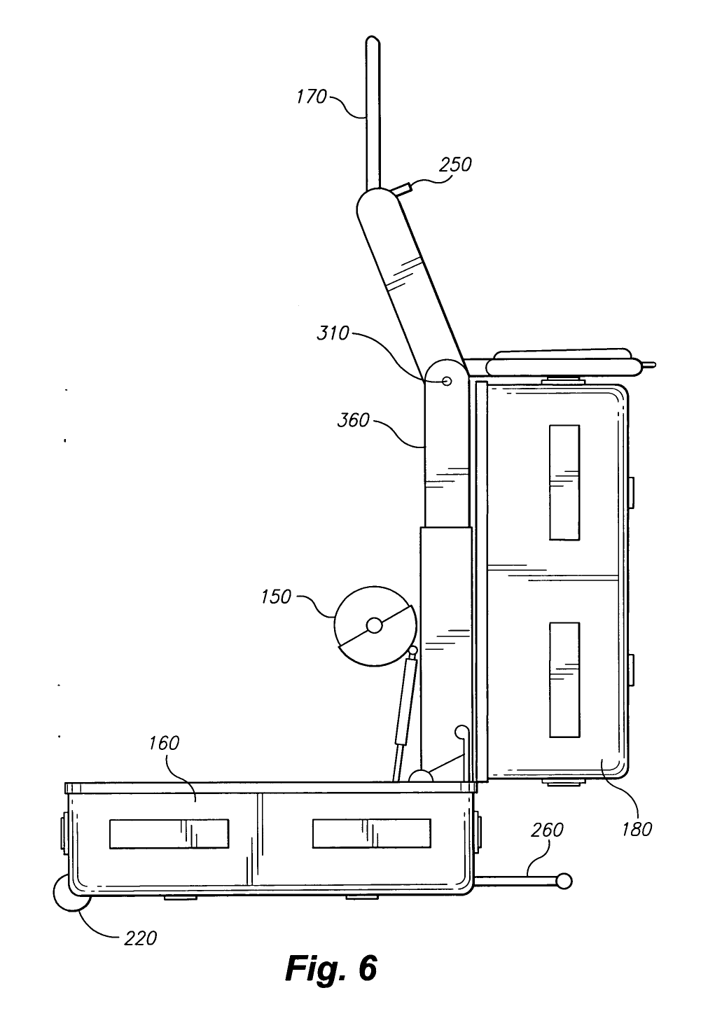

FIG. 6 illustrates a side view of the fully deployed kiosk. As can be seen in FIG. 6, the LCD panel 110, the keyboard 230 and the scanner 270 all rotate around first pivot 310. Further, the top portion 180 of the case rotates about second pivot 320. The first pivot 310 and the second pivot 320 are used to open and close the kiosk. A key advantage of the kiosk 100 of the present invention is that the user does not need to assemble the kiosk. Instead, the kiosk is deployed by folding upper portion 180 of the case about second pivot 320 and the LCD panel, the keyboard 230 and the scanner 270 about the first pivot 310. The method for opening and closing the kiosk will later be described in conjunction with FIGS. 3 and 8-10.

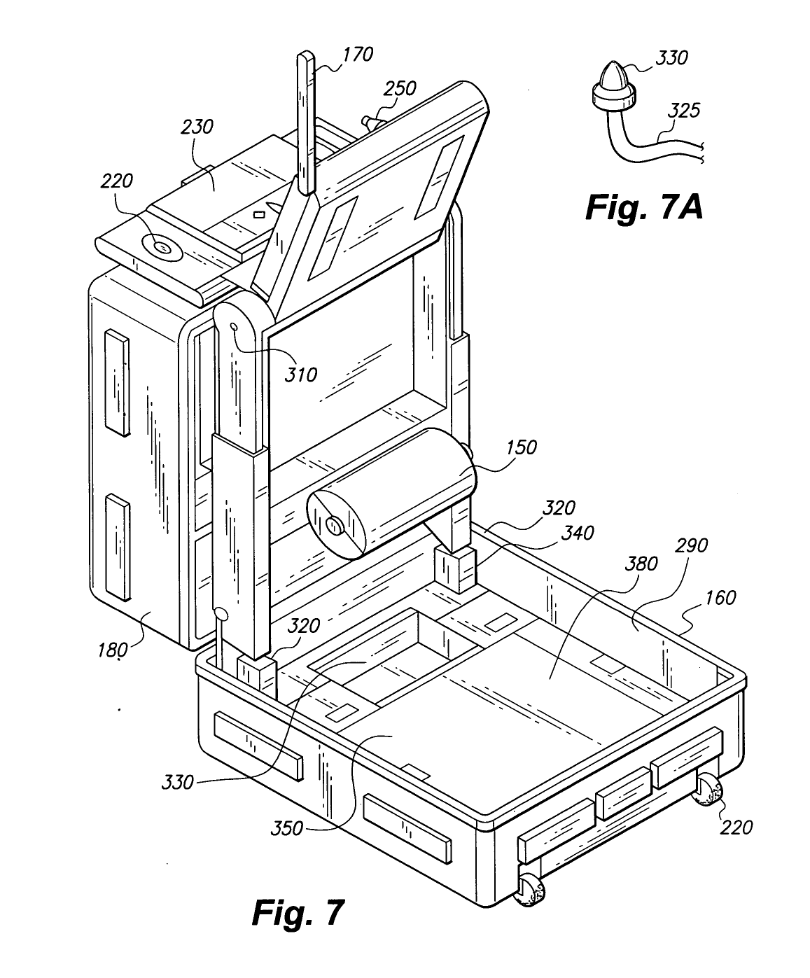

Attention is now directed to FIG. 7, which is a backward-side view of the fully deployed kiosk. When fully deployed, the battery 280 and the power electronics 290 are visible inside the bottom casing 160. Also visible is a line of site communications pod 330 disposed in the lower casing 160. It is to be appreciated that the battery 280 is a Lithium-ion polymer cell or other self-contained power source allowing for four hours (or more) of usage. Power electronics 290 are for allowing the battery 280 to be recharged from an external power source. The external power source can be either a civilian or military power source and can be AC or DC. Also visible in FIG. 7 is a close-up of external line of site communications pod 330 with an end portion of the 100 foot tethered cable 325 connected to the communications pod 330. Reference numeral 345 denotes the hard point mount that locks the floating deck 350 to the case when the kiosk is deployed so that the kiosk electronics complement becomes rigidly fastened to the case structure. Reference numeral 345 denotes a gas piston. At first pivot 310 is a button that enables opening of the kiosk.

It is to be understood that the kiosk 100 is not limited only to those components described above. For example, the kiosk can be modified for other additional uses. One example is to attach an air sampling and monitoring equipment as well as water and solid testing and sampling units that can be used in emergencies as well as in non-emergency situations for nuclear, biological, chemical or environmental monitoring. Other modifications could be sampling, testing and analyzing radiation levels in the air, water and soil and reporting the same over the internet or telephone to a more secure location in both emergency and in non-emergency situations. Such situations can include measuring radiation levels after a bomb is dropped, after an incident at a nuclear power plant, or after a nuclear experiment. One example is to have the kiosk specially equipped to connect air sampling and analyzing devices to the kiosk to test the air quality around a collapsed building or to monitor and measure the radiation levels after a bomb is dropped. The kiosk can then relay the results to a large number of places using the Internet or other telephony means.

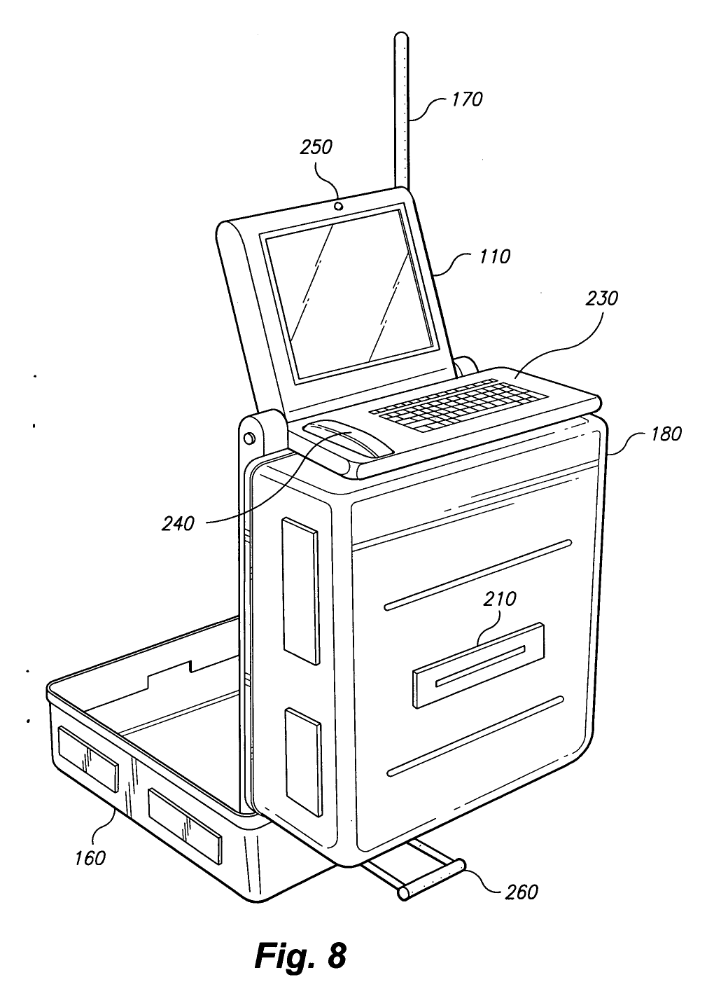

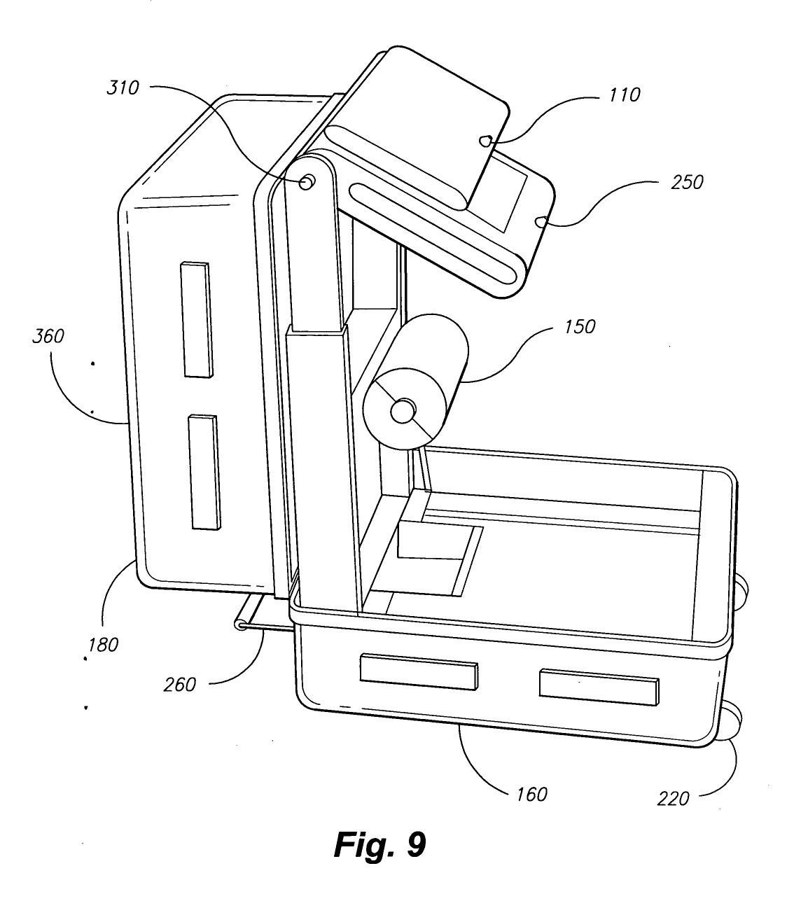

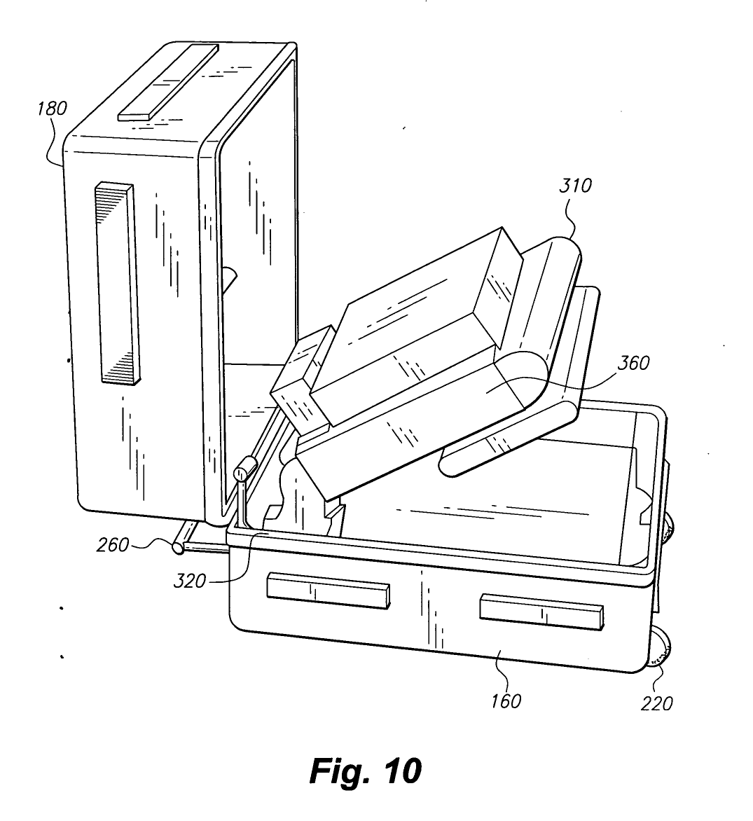

A method of opening and closing the kiosk will now be described with reference to FIGS. 3 and 8-10. Turning to FIG. 8, kiosk 100 is illustrated in a fully deployed position. In order to close the kiosk 100, a button at pivot 310 is pushed while display 110, keyboard 230 and scanner 270 are all rotated about first pivot 310 as illustrated in FIG. 9. The unit has nested struts 368 that extend upward during deployment. After being fully rotated, the entire frame 360 including the paper roll 150 and the display 110 and the keyboard 230 and the scanner 270 are rotated about second pivot 320 as illustrated in FIG. 10. Lastly, the cover 180 is closed onto base 160 as illustrated in FIG. 3.

A method of opening is essentially the reverse of the method of closing. Cover 180 is rotated open, the frame 360 along with the paper roll 150, the display 110, the keyboard 230 and the scanner 270 are all rotated about second pivot 320, and then the display 110, the keyboard 230 and the scanner 270 are rotated about first pivot 310 to arrive at the fully deployed kiosk as illustrated in FIG. 8. It is further noted that the method for opening and closing the kiosk does not require any assembly or attaching of parts. Therefore, the process of opening and closing does not require any special skills or tools and can be accomplished quickly.

While the invention has been particularly shown and described with reference to preferred embodiments thereof, it will be understood by those skilled in the art that the foregoing and other changes in form and details may be made therein without departing from the spirit and scope of the invention.

1. A portable kiosk, comprising:
means defining a first pivot;
a display panel and a scanner rotatable about said first pivot;
means defining a second pivot;
said first pivot, a computer and a printer rotatable about a second pivot; and
a battery;
said portable kiosk being foldable about said first and said second pivots to form a carrying case.

2. The kiosk of claim 1, further comprising a telephone that is rotatable about said first pivot.

3. The kiosk of claim 1, further comprising a fingerprint scanner rotatable about said first pivot, said fingerprint scanner electrically connected to said computer.

4. The kiosk of claim l, further comprising a digital camera located on a top of said display panel, said digital camera being connected to said computer.

5. The kiosk of claim 1, further comprising an antenna for use with a cellular, satellite or wireless connection enabling said computer to have Internet or other network access.

6. The kiosk of claim 1, said case having a sealable perforation, said printer expelling paper through said sealable perforation in said carrying case.

7. The kiosk of claim 1, further comprising a keyboard rotatable about said first pivot and disposed between said scanner and said display.

8. The kiosk of claim 1, said display being an LCD display.

9. The kiosk of claim 8, said display being touch-sensitive.

10. The kiosk of claim 1, said kiosk being foldable into a carrying case having approximate dimensions of 24.5 inches wide, 27.5 inches long and only 18.5 inches high.

11. The kiosk of claim 10, said kiosk being about 53 inches high when deployed.

12. The kiosk of claim 10, said kiosk weighing about 95 lbs.

13. A method for deploying a kiosk from a carrying case, comprising the steps of:
unlocking the carrying case;
rotating a cover of the carrying case away from a base of the carrying case;
rotating a computer and peripherals about a first pivot to an upright position; and
rotating a display about a second pivot to a viewable position.

14. The method of claim 13, the second pivot being disposed on top of the first pivot after said first rotating step.

15. The method of claim 13, wherein a keyboard and a scanner are also rotated to an operable position in said second rotating step.

16. The method of claim 13, further comprising the steps of turning on power to said kiosk and logging in to said kiosk via a fingerprint scanner.

17. A method for storing a kiosk in a portable carrying case, comprising the steps of:
rotating a display and a keyboard about a first pivot until folded against a computer body;
rotating the computer body with the keyboard and the display about a second pivot so that the computer body, display and keyboard are located within a base of a carrying case; and
closing a cover of the carrying case onto the base of the carrying case containing said computer, the keyboard and the display.

18. The method of claim 17, further comprising the step of locking the cover onto the base of the carrying case.

19. The method of claim 17, further comprising the step of carrying the carrying case using a handle disposed on the base, and rolling the carrying case via rollers disposed on said base of the carrying case opposite the handle.
